(19) United States
(12) Patent Application Publication
(10) Pub. No.: US 2018/0025853 A1
(43) Pub. Date: Jan. 25, 2018

(54) METHOD OF DEPOSITING OXIDIZED CARBON-BASED MICROPARTICLES AND NANOPARTICLES

(71) Applicant: THALES, Courbevoie (FR)

(72) Inventors: Paolo BONDAVALLI, Palaiseau (FR); Grégory POGNON, Palaiseau (FR); Christophe GALINDO, Palaiseau (FR)

(21) Appl. No.: 15/548,710

(22) PCT Filed: Feb. 5, 2016
(86) PCT No.: PCT/EP2016/052541

§ 371 Date: Aug. 3, 2017

(30) Foreign Application Priority Data
Feb. 6, 2015 (FR) 1500231

(51) Int. Cl. H01G 11/36; C01B 32/23; B05D 1/02; B05D 3/00; H01G 11/24; H01G 11/86

(52) U.S. Cl. CPC H01G 11/36; H01G 11/24; H01G 11/86; B05D 1/02; B05D 3/007; C01B 32/23; B82Y 30/00

(57) ABSTRACT

A process for the deposition of nano/microparticles, including at least graphene sheets on a support, comprises the following steps: oxidizing at least the graphene sheets; suspending the nano/microparticles in at least one solution comprising at least water as solvent; spraying, by hydrodynamic instability, each suspension over the substrate; heating the substrate, during each spraying, so as to promote the complete evaporation of the solvent from each part of each suspension sprayed over the substrate at a temperature less than or equal to one and a half times the boiling point of each solution and less than or equal to 200° C.; annealing the deposit after the spraying(s) at a temperature sufficient to deoxidize at least the oxidized graphene present in the deposit and greater than the temperature of the substrate during the deposition step.

The invention relates to components for the storage of energy, in particular capacitors. The capacitors concerned are also known as “supercapacitors”, characterized by a greater energy density than that of dielectric capacitors and a higher power density than that of batteries.

Supercapacitors generally comprise two porous electrodes impregnated with an electrolyte (an ionic salt in generally organic solution, a quaternary ammonium salt, such as tetraethylammonium tetrafluoroborate in acetonitrile or propylene carbonate, for example). These electrodes are generally separated by an insulating and porous membrane which makes possible the circulation of the ions of the electrolyte.

The first supercapacitors, known as “EDLCs” (Electrochemical Double Layer Capacitators), are based on a principle equivalent to that of conventional capacitors with polarizable electrodes and an electrolyte acting as dielectric. Their capacity originates from the arrangement of a double layer of ions and of electrons at the electrolyte/electrode interface. Today, supercapacitors combine, for the storage of energy, a capacitive component resulting from the electrostatic arrangement of the ions close to the electrodes and a pseudocapacitive component due to oxidation/reduction reactions in the capacitor.

The electrostatic component of the storage of energy is produced by a nonhomogeneous distribution of the ions of the electrolyte in the vicinity of the surface of each electrode, under the effect of the difference in potential applied between the two electrodes. The electrostatic component of the storage of energy confers a potentially high specific power and a very good behaviour during the charging and discharging cycles.

Materials having a very high ratio of specific surface to volume, having a porosity suited to ion storage at this scale, have been developed in order to increase the capacity of supercapacitors. The methods for manufacturing these materials have been directed towards the use of fullerenes, carbon nanotubes, activated carbon, carbon nanofibers or CNFs and graphene, which are advantageously light, inexpensive and ecologically appropriate.

Supercapacitors might replace conventional capacitors for applications having a high energy demand, exhibiting in particular extreme temperatures, vibrations, high accelerations or a high salinity. In these environments, batteries may not operate without their lifetime being greatly restricted (these conditions apply to radars, to motor sports, to electrical avionics and to military applications, for example).

Supercapacitors can also be applied to systems which require energy peaks over short times, of the order of the minute, for phases of acceleration of vehicles in ground transportation (motor vehicles, tramways, buses, “stop and start” devices, in which energy is recovered during the deceleration).

Supercapacitors might also be useful for the management of electricity in onboard systems, for rendering electrical installations secure, for rendering the energy supply of sensitive systems secure (radio sets, monitoring systems, military field, data centre), in networks of self-contained sensors for applications in monitoring industrial, complex or sensitive sites (hospitals, avionics, offshore platform, oil prospecting, underwater applications) and finally in renewable energies (wind power, recovery of atmospheric electrical energy).

In order to make an industrial application possible, the energy density and the power of supercapacitors have to be optimized. Furthermore, the internal resistance of a supercapacitor is today too high and poorly controlled. The usual supercapacitors are composed of activated carbons with nonhomogeneous and nonoptimized distributions of the size of the pores and use a polymeric binder to ensure the mechanical strength of their structure. This binder increases the internal electrical resistance of the capacitor and disadvantageously increases its weight. The unsuitable porosity also produces a resistance to ion transfer within the active material.

The publication by Bondavalli, P., Delfaure, C., Legagneux, P. and Pribat, D., 2013, “Supercapacitor electrode based on mixtures of graphite and carbon nanotubes deposited using a dynamic air-brush deposition technique”, Journal of The Electrochemical Society, 160(4), A601-A606, discloses a process for the deposition of graphene nano/microparticles and of carbon nanotubes by hydrodynamic spraying of a suspension over a support. This process makes it possible to manufacture supercapacitors achieving high energy and power densities, without use of a polymeric binder, but requires the use of toxic and polluting solvents, such as N-methyl-2-pyrrolidone (NMP) in order to make possible the suspension of the nano/microparticles.

The publication by Youn, H. C., Bak, S. M., Park, S. H., Yoon, S. B., Roh, K. C. and Kim, K. B., 2014, “One-step preparation of reduced graphene oxide/carbon nanotube hybrid thin film by electrostatic spray deposition for supercapacitor applications”, Metals and Materials International, 20(5), 975-981, discloses the use of graphene oxide and of oxidized carbon nanotubes for an electrostatic spraying of a suspension over a support for the manufacture of supercapacitors. This process uses heating at 300° C. during the deposition, of use in the reduction or in the deoxidation of the carbon-based structures present, but limits the manufacture of thick layers as the solution evaporates before the deposition. In addition, this process uses a water/ethanol mixture as solvent for the suspension of the oxidized particles. This characteristic reduces the evaporation temperature of the solvent, which also promotes evaporation of the solvent before deposition on the substrate and prevents the manufacture of a thick layer. Furthermore, the use of ethanol in the solvent is toxic and is not ecologically appropriate.

A subject-matter of the present invention is a process for the deposition of nano/microparticles, including at least graphene sheets, on a substrate, comprising the steps consisting in:
oxidizing at least the said graphene sheets;
suspending the said nano/microparticles in at least one solution comprising at least water as solvent;
spraying, by hydrodynamic instability, each suspension over the said substrate;
heating the said substrate, during each spraying, so as to promote the complete evaporation of the said solvent from each part of each said suspension sprayed over the said substrate at a temperature less than or equal to one and a half times the boiling point of each said solution and less than or equal to 200° C.;
annealing the said deposit after the said spraying(s) at a temperature sufficient to deoxidize at least the oxidized graphene present in the said deposit and greater than the temperature of the said substrate during the deposition step.

Advantageously, the said nano/microparticles are suspended in one said solution, the said solvent of which is more than 95% by weight composed of water (H₂O) and preferably more than 99% by weight composed of water.

Advantageously, a plurality of said suspensions are simultaneously sprayed over the said substrate.

Advantageously, the nano/microparticles of the deposition process are chosen from carbon nanotubes, carbon nanofibers, carbon nanorods, carbon nanohorns, carbon onions and a mixture of these nano/microparticles, in which the said nano/microparticles are oxidized before spraying them and in which the said deposit, after the said spraying, is annealed at a temperature sufficient to deoxidize the said nano/m icroparticles.

Advantageously, at least one said nano/microparticle is wet oxidized with at least one element chosen from sulphuric acid, phosphoric acid, sodium nitrate, nitric acid, potassium permanganate and hydrogen peroxide.

Advantageously, a heating element brought into contact with a support heats the said substrate and each said part of said suspension sprayed over the said substrate.

Advantageously, the said deposit is annealed at a temperature of between 200° C. and 400° C.

The invention also relates to a process for the manufacture of an electrode comprising, in superimposition, a deposit of nano/microparticles and a substrate, the said substrate comprising a current collector and the said deposit of nano/microparticles being obtained by a deposition process described above.

The present invention also relates to an electrode, the said deposit of nano/microparticles of which is capable of being obtained by a process described above.

Advantageously, the said deposit of the electrode comprises at least graphene and a type of said nano/microparticles chosen from carbon nanotubes, carbon nanofibers, carbon nanorods, carbon nanohorns and carbon onions.

The present invention also relates to a supercapacitor comprising at least one said electrode described above.

The following description exhibits several implementational examples of the device of the invention: these examples are nonlimiting of the scope of the invention. These implementational examples exhibit both the essential characteristics of the invention and also additional characteristics related to the embodiments under consideration. For the sake of clarity, the same elements will bear the same references in the different figures.

“Nanopartcle” is understood to mean particles, at least the smallest of the dimensions of which is nanometric, that is to say of between 0.1 nm and 100 nm. “Microparticle” is understood to mean particles, at least the smallest of the dimensions of which is micrometric, that is to say of between 0.1 μm and 100 μm.

The geometries of nano/microparticles comprise nano/microfibers, nano/microrods, nano/microtubes, nano/microhorns, nano/microonions and nano/microsheets of the monolamellar type comprising a crystalline layer or multilamellar type comprising several stacked lamellae. A nano/microtube is formed of one or more wound nano/microsheets. A nano/microfiber is a solid one-dimensional object of a bulk material. A nano/microrod is a hollow one-dimensional object.

In the case of carbon, a lamella is denoted by the term “graphene” and exists in the form of a two-dimensional carbon crystal of monoatomic thickness and of nano/micrometric size. The carbon nanotubes are known and formed of a graphene lamella wound into a tube (denoted by the acronym of SWCNT (Single Wall Carbon NanoTube)) or of several stacked graphene lamellae wound into a tube (denoted by the acronym of MWCNT (Multi Wall Carbon NanoTube)).

“Electrode” is understood to mean an assembly comprising a deposit of nano/microparticles on a substrate (comprising a current collector which electrically conducts and optionally a thick material or layer for the mechanical strength of the electrode).

A better understanding of the invention will be obtained and other advantages, details and characteristics of the invention will become apparent during the explanatory description which follows, made by way of example with reference to the appended drawings, in which:

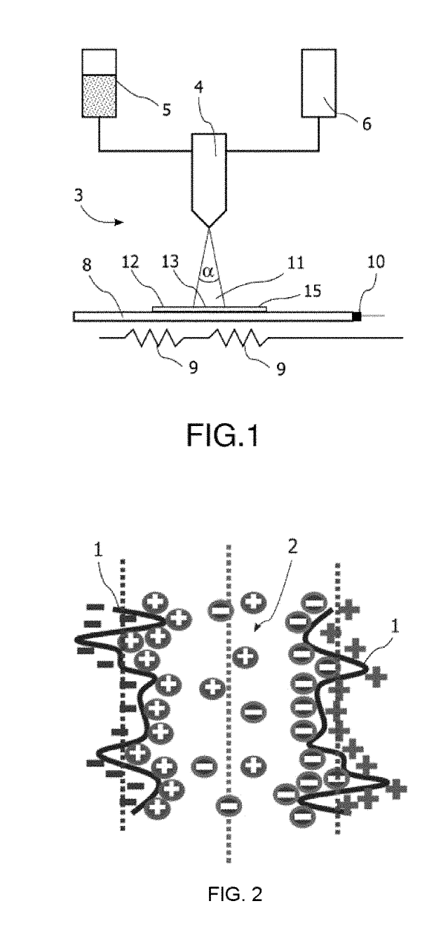

FIG. 1 is a diagrammatic representation of an apparatus for carrying out the deposition of nano/microparticles according to a process in accordance with the invention;

FIG. 2 is a diagrammatic representation of two deposits of nano/microparticles and of the electrolyte of a supercapacitor;

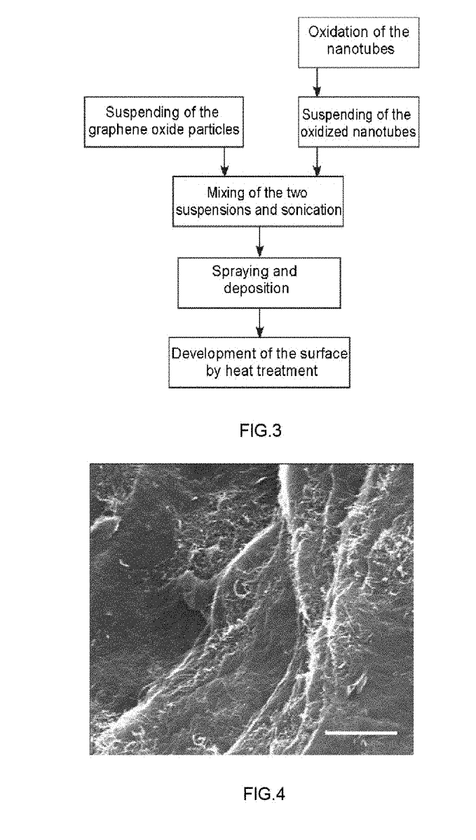

FIG. 3 is a diagrammatic representation illustrating a specific implementation of a process in accordance with the invention;

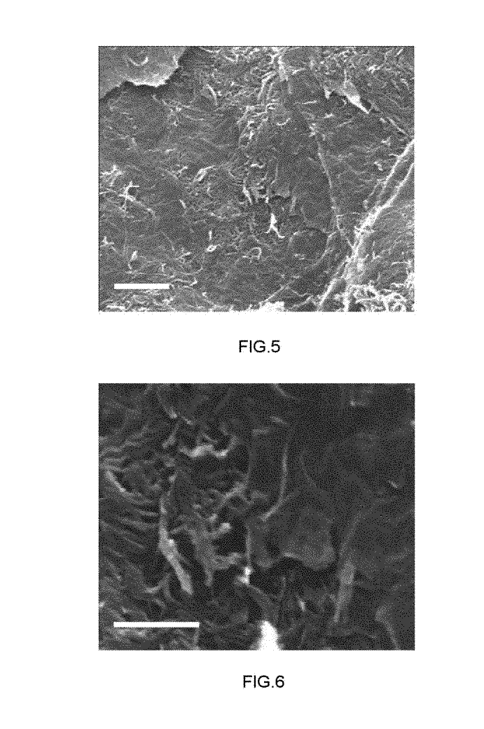

FIG. 4 is a photograph taken with a scanning electron microscope of the structure of the material from a deposition of nano/microparticles carried out according to a process in accordance with the invention;

FIG. 5 is a photograph taken by a scanning electron microscope of the structure of the material from a deposition of nano/microparticles carried out according to a process in accordance with the invention;

FIG. 6 is a photograph taken by a scanning electron microscope of the structure of the material from a deposition of nano/microparticles carried out according to a process in accordance with the invention;

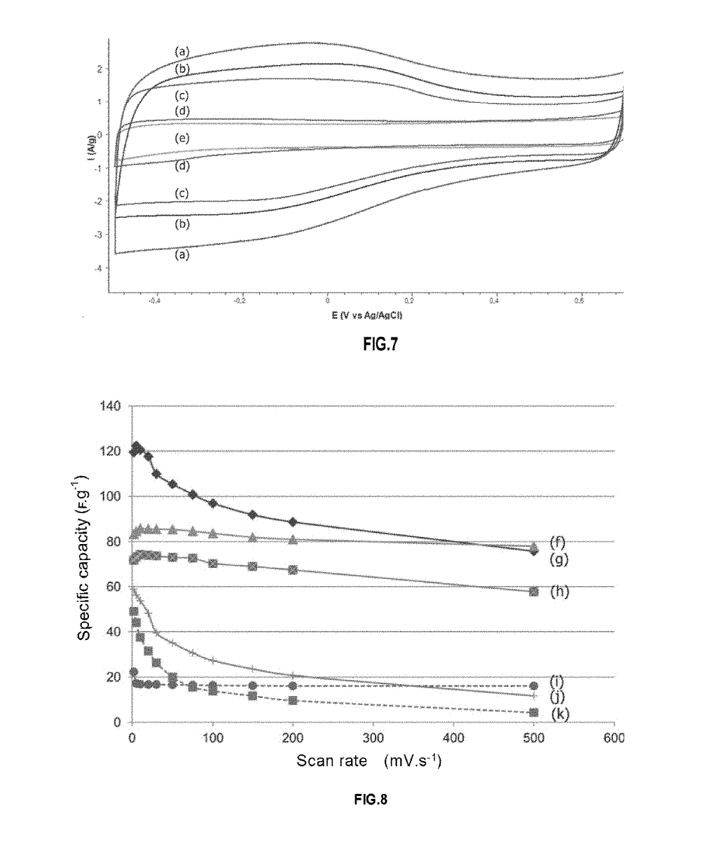

FIG. 7 exhibits cyclic voltammograms obtained from deposits of nano/microparticles of different compositions;

FIG. 8 illustrates the influence of the cycling rate on the capacity of deposits of nano/microparticles of different compositions, and

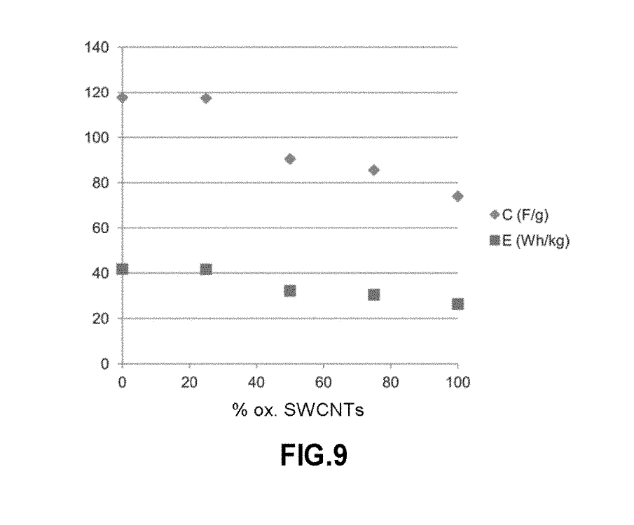

FIG. 9 illustrates the value of the specific capacity and of the energy density of an electrode as a function of the proportion of oxidized carbon nanotubes in the sprayed suspension.

The following description exhibits several implementational examples of the device of the invention: these examples are nonlimiting of the scope of the invention. These implementational examples exhibit both the essential characteristics of the invention and also additional characteristics related to the embodiments under consideration. For the sake of clarity, the same elements will bear the same references in the different figures.

FIG. 1 is a diagrammatic representation of an apparatus 3 for carrying out deposition of nano/microparticles according to a process in accordance with the invention.

The apparatus 3 comprises a spray nozzle 4, a tank 5 containing a suspension of nano/microparticles and a spray gas source 6. The nano/microparticles comprise oxidized graphene particles and can comprise, in specific implementations of the invention, oxidized carbon nanotubes, oxidized carbon nanofibers, oxidized carbon nanorods, oxidized carbon nanohorns and oxidized carbon onions. Other nanoparticles can be envisaged.

The solvent used for the suspension can advantageously be composed of more than 95% of water (H₂O) and more advantageously still composed of more than 99% of water (H₂O). In specific implementations of the invention, water can be mixed with other solvents, in proportions which allow them to remain miscible with the water, such as a methanol (CH₄O), ethanol (C₂H₆O), ethylene chloride (DCE), dichlorobenzidine (DCB), N-methyl-2-pyrrolidone (NMP), dimethylformamide (DMF), hexamethylphosphoramide (HMPA), cyclopentanone (C₅H₈O), tetramethylene sulphoxide (TMSO), ε-caprolactone, 1,2-dichlorobenzene, 1,2-dimethylbenzene, bromobenzene, iodobenzene and toluene. Other compounds can be envisaged.

The spray gas is, for example, air.

The nozzle 4 is fed with suspension from the tank 5 and with spray gas from the source 6. The nozzle 4 is suitable for spraying the suspension, fed at low pressure, as microdrops using the gas, fed at high pressure. The nozzle 4 is of the airbrush type. The drops are created by hydrodynamic instability between the liquid phase, the gas phase and the nozzle 4, i.e., in a specific implementation of the invention, sprayed by effect of the pressure imposed on the water, on the air and on the geometry of the nozzle.

“Microdrops” is understood to mean drops with a size of a microscopic nature, the diameter of which is between approximately 1 and 100 micrometres.

In a specific implementation of the invention, the apparatus 3 comprises elements 7 for heating the support 8 in the form of resistive heating elements 9 connected to an electrical supply circuit (not represented) so that the resistive heating elements 9 emit heat by the Joule effect when an electric current passes through them. In an alternative form, the apparatus 3 comprises elements 7 for heating the support 8 by induction, for example comprising a plate on which the support 8 is placed with inductors, in order to induce currents in the plate and to generate heat.

The apparatus 3 comprises a temperature sensor 10 positioned so as to measure the temperature of the support 8.

In operation, the nozzle 4 generates a spray jet 11 formed of suspension microdrops projected in the direction of the surface 12 to be covered of the substrate 15. The spray jet 11 reaches the surface 12 to be covered in an impact zone 13, the shape and the dimensions of which depend in particular on the geometry of the nozzle 4, on the adjustment of the nozzle 4 and on the position of the nozzle 4 with respect to the surface 12 to be covered.

The shape and the dimensions of the impact zone 13 depend in particular on the angle a at the top of the cone formed by the spray jet 11 at the outlet of the nozzle 4 and on the distance between the outlet of the nozzle 4 and the surface 12 of the substrate 15. They also depend on the pressure of the spray gas (related to the spray gas flow rate and on the flow rate of each suspension.

The spray jet 11 is, for example, a cone of revolution, so it forms an impact zone 13 of circular general shape. In an alternative form, the spray jet 11 might define an oblong impact zone 13, which is more elongated in a first direction than in a second direction perpendicular to the first.

FIG. 2 is a diagrammatic representation of two deposits of nano/microparticles 1 and of the electrolyte 2 of a supercapacitor. The storage of the energy is carried out by a nonhomogeneous distribution of the ions of the electrolyte 2 in the vicinity of the surface of each deposit of nano/microparticles 1. During a polarization of the electrodes, several ionic layers can be formed in the vicinity of the surface of the deposits of nano/microparticles 1 and exhibit a thickness of the order of a few nanometres, according to the electrolyte 2 under consideration and its concentration. The origin of these layers is electrostatic. This process does not involve electrochemical transformation of the matter, as in the case of batteries.

FIG. 2 illustrates the importance of developing materials having very wide specific surfaces and possessing a porosity appropriate for ion storage at this scale, in order to increase the storage capacities of supercapacitors.

In a specific implementation of the invention, the nano/microparticles used to form a deposit 1 can be graphene sheets and single wall carbon nanotubes (SWCNT).

FIG. 3 is a diagrammatic representation illustrating a specific implementation of a process according to the invention. It illustrates the formation of one or more deposits of nano/microparticles 1 manufactured on a substrate 15 (comprising a current collector, conductor and optionally a thick layer for its mechanical strength) in superimposition with the support.

In a first stage, the carbon-based nano/microparticles are oxidized. The carbon-based nano/microparticles are, for example, SWCNTs. SWCNTs are dispersed in a mixture of equal volumes of sulphuric acid and nitric acid for 30 minutes. The mixture is subsequently refluxed for 3 hours. The SWCNTs are then oxidized. They can be recovered by filtering the mixture under vacuum and by washing them with several hundred millilitres of water until a neutral pH of the filtrate is obtained. The product is dried under vacuum at 70° C. for several days.

The graphene oxide particles can be obtained commercially.

In a second stage, suspensions of each of the different particles in deionized water can be prepared by sonication for one hour, at a concentration of between 5 μg·ml⁻¹ and 50 mg·ml⁻¹ and preferably between 50 μg·ml⁻¹ and 5 mg·ml⁻¹. It is possible subsequently to combine together the different suspensions into just one suspension and to place the suspension under ultrasound for one hour.

In a third stage, the nano/microparticles are deposited on the current collector of the substrate 15. Deposition is carried out by spraying the suspension by hydrodynamic instability over a substrate 15 heated to a temperature preferably of greater than 100° C. and preferably of less than or equal to 200° C., indeed even 150° C.: the temperature has to be sufficient to make possible rapid evaporation of the drops deposited by spraying and to thus prevent the “coffee stain” effect, that is to say a nonhomogeneous surface distribution of adsorbed nano/microparticles. On the other hand, an excessively high temperature, such as that presented in the process presented by Youn et al., would bring about a complete evaporation of the drops during their journey between the nozzle 4 and the support 8, thus preventing a controlled and efficient adsorption or attachment. As a minimum, the process of Youn et al. requires the use of a high suspension volume in order to compensate for the total evaporation, induced by a high temperature, of a high proportion of the sprayed suspension.

In a fourth stage, the deposit 1 is annealed at a temperature of greater than 200° C. in order to deploy the surfaces accessible by the electrolyte 2 in the deposit of nano/microparticles 1, to reduce or deoxidize the graphene oxide and the oxidized nanotubes and to increase the conductivity of the deposit of de nano/microparticles 1. This step is necessary as the deposition temperature is too low to reduce or to deoxidize the nano/microparticles of the deposit 1. This step exhibits two distinct advantages with respect to the process presented by Youn et al.; on the one hand, the annealing makes it possible to deoxidize the nano/microparticles at an effective temperature while retaining a lower temperature during the spraying (and the advantages which are related thereto and presented in the preceding paragraph). On the other hand, the annealing can be carried out in a controlled manner, by applying, for example, an equal annealing time for all of the particles to be deposited. Disadvantageously, in the process presented by Youn et al., the particles deposited at the start of the spraying will be subjected to a different annealing time from the particles deposited at the end of the spraying.

During this implementation of the process in accordance with the invention, the two types of carbon-based structures are organized into a hierarchy during the deposition by spraying over the substrate 15 heated by the support 8, which makes it possible to instantaneously evaporate the water. This organization into a hierarchy is illustrated by FIG. 4, FIG. 5 and FIG. 6.

FIGS. 4, 5 and 6 are photographs taken by a scanning electron microscope of the structure of the material of a deposition of nano/microparticles 1 carried out according to a process in accordance with the invention. They illustrate the hierarchized structure, the obtaining of which is described above: the oxidized carbon nanotubes are inserted between the oxidized graphene lamellae. The homogeneous distribution of the two structures is already potentially initiated in the suspension before spraying, via possible esterifications between the hydroxyl and carboxyl groups of each of the two oxidized carbon-based structures. In a specific and different implementation of the invention, other oxidized carbon-based structures can be introduced into the sprayed suspension, such as carbon nanofibers, carbon nanorods, carbon nanohorns and carbon onions.

FIG. 7 exhibits cyclic voltammograms obtained from deposits of nano/microparticles 1 of different compositions. The different measurements are carried out at a scan rate of 20 mV·s⁻¹, in a three-electrode setup: the electrode comprising a deposit of nano/microparticles 1, an Ag/AgCl electrode and a 3 M LiNO₃ electrode. The curve (a) corresponds to a deposit of nano/microparticles obtained according to a process of the invention using oxidized graphene nano/microparticles. The curve (b) corresponds to a deposit of nano/microparticles 1 obtained according to a process of the invention using oxidized graphene nano/microparticles and oxidized carbon nanotubes mixed in equal proportions by weight. The curve (c) corresponds to a deposit of nano/microparticles 1 obtained by using sprayed oxidized carbon nanotubes. The curve (d) corresponds to a deposit of nano/microparticles 1 obtained by using graphene nano/microparticles and carbon nanotubes which are sprayed (materials not oxidized beforehand, suspended in an NMP solvent). Finally, the curve (e) corresponds to a deposit of nano/microparticles 1 manufactured as a disorderly mat or buckypaper of carbon nanotubes and graphene in proportions by weight of 50%/50%.

The rectangular shape of the different cyclic voltammograms of FIG. 7 illustrates the capacitive nature of the different electrodes measured. FIG. 7 furthermore illustrates an increase in the current density measured when the deposits of nano/microparticles 1 are manufactured from oxidized nano/microparticles (curves (a), (b) and (c)).

FIG. 8 illustrates the influence of the cycling rate on the specific capacity of electrodes covered with a deposit of nano/microparticles 1 of different compositions. The curve (f) corresponds to a deposit of nano/microparticles 1 obtained according to a process of the invention using oxidized graphene and oxidized SWCNT nano/microparticles, in proportions by weight respectively of 25%/75%, which are sprayed over a substrate 15 heated to 200° C. The heating of the substrate 15 to 170° C. gives similar results. The curve (g) corresponds to a deposition of nano/microparticles 1 obtained according to a process of the invention using oxidized graphene nano/microparticles, the curve (h) corresponds to a deposition of nano/microparticles 1 obtained by spraying oxidized SWCNTs, the curve (i) corresponds to a deposition of nano/microparticles 1 based on buckypaper with SWCNTs, the curve (j) corresponds to a deposition of nano/microparticles 1 manufactured from activated carbon paste (such as in conventional supercapacitors) and the curve (k) corresponds to a deposit of nano/microparticles based on buckypaper with a mixture of oxidized graphene and oxidized SWCNT nano/microparticles.

For all of the cycling rates, FIG. 8 shows that the specific capacities are higher in the case of the electrodes whose deposits of nano/microparticles are manufactured via the spraying method in comparison with the manufacturing methods using buckypaper and activated carbon paste. Furthermore, FIG. 8 illustrates that, among the deposits of nano/microparticles 1 manufactured by spraying, the specific capacities of the electrodes obtained according to a process of the invention are higher than those of the electrode manufactured with deposits 1 of oxidized SWCNTs (alone).

The crossing of the curves (f) and (g) shows the advantage of an interaction between oxidized graphene and oxidized SWCNT nano/microparticles in order to retain a high specific capacity even at a high cycling rate. Furthermore, the curve (f) illustrates that the interaction between oxidized graphene and oxidized SWCNT nano/microparticles makes it possible to retain relatively stationary specific capacity values.

FIG. 9 illustrates the value of the specific capacity and of the energy density of an electrode as a function of the proportion of oxidized SWCNTs in the sprayed suspension, during the use of an electrode obtained according to a process of the invention using oxidized graphene and oxidized SWCNT nano/microparticles. The specific capacity and the energy density are optimal for a proportion by weight of SWCNTs of between 0 and 25%.

1. A process for the deposition of nano/microparticles, including at least graphene sheets, on a substrate, comprising the following steps:
oxidizing at least the said graphene sheets;
suspending the said nano/microparticles in at least one solution comprising at least water as solvent;
spraying, by hydrodynamic instability, each suspension over the said substrate;
heating the said substrate, during each spraying, so as to promote the complete evaporation of the said solvent from each part of each said suspension sprayed over the said substrate at a temperature less than or equal to one and a half times the boiling point of each said solution and less than or equal to 200° C.;
annealing the said deposit after the said spraying(s) at a temperature sufficient to deoxidize at least the oxidized graphene present in the said deposit and greater than the temperature of the said substrate during the deposition step.

2. The deposition process according to claim 1, wherein the said nano/microparticles are suspended in one said solution, the said solvent of which is more than 95% by weight composed of water (H₂O) and preferably more than 99% by weight composed of water.

3. The deposition process according to claim 1, wherein a plurality of said suspensions are simultaneously sprayed over the said substrate.

4. The deposition process according to claim 1, the said nano/microparticles of which are chosen from carbon nanotubes, carbon nanofibers, carbon nanorods, carbon nanohorns, carbon onions and a mixture of these nano/microparticles, wherein the said nano/microparticles are oxidized before spraying them and wherein the said deposit, after the said spraying, is annealed at a temperature sufficient to deoxidize the said nano/microparticles.

5. The process according to claim 1, wherein at least one said nano/microparticle is wet oxidized with at least one element chosen from sulphuric acid, phosphoric acid, sodium nitrate, nitric acid, potassium permanganate and hydrogen peroxide.

6. The deposition process according to one of claim 1, wherein a heating element brought into contact with a support heats the said substrate and each said part of said suspension sprayed over the said substrate.

7. The deposition process according to claim 1, wherein the said deposit is annealed at a temperature of between 200° C. and 400° C.

8. A process for the manufacture of an electrode comprising, in superimposition, a deposit of nano/microparticles and a substrate, the said substrate comprising a current collector, the said deposit of nano/microparticles being obtained by a process according to claim 1.

9. An electrode, the said deposit of nano/microparticles of which is capable of being obtained by a process according to claim 1.

10. The electrode according to claim 9, wherein the said deposit comprises at least graphene and a type of said nano/microparticles chosen from carbon nanotubes, carbon nanofibers, carbon nanorods, carbon nanohorns and carbon onions.

11. A supercapacitor comprising at least one said electrode according to claim 9.
